(19) United States
(12) Patent Application Publication
(10) Pub. No.: US 2021/0390303 A1
(43) Pub. Date: Dec. 16, 2021

(54) METHOD AND DEVICE FOR MONITORING AN INDUSTRIAL PROCESS STEP

(71) Applicant: WAGO Verwaltungsgesellschaft mbH, Minden (DE)

(72) Inventors: Thomas NEUMANN, Villingen-Schwenningen (DE); Daniel MARCEK, Haigerloch-Stetten (DE); Florian WEISS, Furtwangen (DE)

(73) Assignee: WAGO Verwaltungsgesellschaft mbH, Minden (DE)

(21) Appl. No.: 17/446,042

(22) Filed: Aug. 26, 2021

Related U.S. Application Data
(63) Continuation of application No. PCT/EP2020/054991, filed on Feb. 26, 2020.

(30) Foreign Application Priority Data
Feb. 26, 2019 (DE) 10 2019 104 822.2

(51) Int. Cl. G06K 9/00; G06N 20/00; H04N 7/18; G06T 7/00

(52) U.S. Cl. CPC G06K 9/00664; G06N 20/00; H04N 7/185; G06T 2207/20084; G06T 2207/20081; G06T 2207/30108; G06T 7/0004

(57) ABSTRACT

A method for monitoring an industrial process step of an industrial process by a monitoring system. A machine learning system of the monitoring system is provided that contains a correlation between digital image data as input data and process states of the industrial process step to be monitored as output data using at least one machine-trained decision algorithm. Digital image data is recorded by at least one image sensor of at least one image acquisition unit of the monitoring system. At least one current process state is determined using the decision algorithm by generating at least one current process state of the industrial process step as output data rom the recorded digital image data as input data of the machine learning system. The industrial process step is monitored by generating a visual, acoustic and/or haptic output as a function of the at least one determined current process state.

This nonprovisional application is a continuation of International Application No. PCT/EP2020/054991, which was filed on Feb. 26, 2020 and which claims priority to German Patent Application No. 10 2019 104 822.2, which was filed in Germany on Feb. 26, 2019, and which are both herein incorporated by reference.

### BACKGROUND OF THE INVENTION

### Field of the Invention

The present invention relates to a method for monitoring an industrial process step of an industrial process via a monitoring system. The invention also relates to a monitoring system for this.

### Description of the Background Art

In industrial production, even today, some manual process steps are required, which must be carried out manually by a person. Especially in the field of quality assurance, manual process steps or process steps by hand are required, which must be actively carried out by a person in order to inspect the product in terms of its predefined properties and, if necessary, to document the inspection.

But even in subprocesses in production in which manual process steps, carried out by a specialist, are still required, it is desirable to inspect or monitor the manually executed process steps with regard to their correctness, in keeping with quality assurance. Errors during the manual processing of the process steps of the entire industrial process can lead to system downtime or damage to the system in subsequent automated subprocesses, which requires additional maintenance and set-up times. In addition, any incorrectly executed process steps are only discovered at the end in the quality assurance phase, which leads to a huge waste of resources.

EP 1 183 578 B1, which corresponds to US 2002/00046368, discloses a device which describes an augmented reality system with a mobile device for the context-dependent display of assembly instructions.

EP 1 157 316 B1 discloses a system and a method for the situation-relevant support of an interaction using augmented reality technologies. For optimized support, especially during system setup, commissioning and maintenance of automation-controlled systems and processes, it is proposed that a specific work situation is automatically recorded and statistically analyzed.

US 2002/0010734 A1 discloses a networked augmented reality system, which consists of one or more local stations or several local stations and one or more remote stations. The remote stations can provide resources that are not available in a local station, e.g., databases, high-performance computers, etc.

U.S. Pat. No. 6,463,438 B1 discloses an image recognition system, which is based on a neural network, for detecting cancer cells and for classifying tissue cells as normal or abnormal.

### SUMMARY OF THE INVENTION

It is therefore an object of the present invention to provide an improved method and an improved device with which the manual process steps of an industrial process can be monitored with regard to quality assurance.

Thus, a method for monitoring an industrial process step of an industrial process via a monitoring system is provided, wherein first a machine learning system of the monitoring system is provided. The machine learning system provided has at least one machine-trained decision algorithm which includes a correlation between digital image data as input data and process states of the industrial process step as output data. The machine learning system thus provides a system with at least one decision algorithm in which digital image data has been learned as input data, with regard to its corresponding process states, in such a way that corresponding process states can be derived and determined from the learned correlation by entering digital image data using the principle of learned generalization.

To monitor the industrial process step, in particular a process step carried out manually by a person, digital image data is now continuously recorded by means of at least one image sensor of at least one image acquisition unit. The digital image sensor can be worn by the person on the body and thus records digital image data in particular in the person's field of view or area of handling. It may be provided that several persons are involved in the process step to be carried out, wherein several of these persons may be equipped with an image acquisition unit. However, it is also conceivable that the field of view and/or area of handling of one or more persons is recorded by at least one stationary image acquisition unit and the respective image sensors.

These digital image data recorded by the at least one image acquisition unit are transmitted via a wired or wireless connection to the machine learning system having the at least one decision algorithm, wherein on the basis of the digital image data as input data into the decision algorithm of the machine learning system, the process states trained for this purpose are determined as output data. Based on the determined process state, an output unit is now controlled in such a way that a visual, acoustic and/or haptic output is outputted to a person, for example to the persons involved in the process.

For example, it is conceivable that in a recognized process state that characterizes an incorrect status of the process step, a corresponding visual, acoustic and/or haptic warning is issued to the person in order to focus attention on the faulty process flow.

This makes it possible that when process errors develop in the execution of, in particular, manual process steps, the person can be informed of the respective incorrectly executed process sequence, so that such a faulty process sequence does not propagate further in the entire industrial process, thus possibly causing greater damage. Rather, the present invention makes it possible to detect errors in the execution of manual process steps when they emerge and to point them out to the person concerned. In addition, in terms of manual quality assurance, the person responsible for quality assurance is also supported by the automatic detection of defective components and thus improvement of the process step of quality assurance, making it more efficient. In addition, with the help of the present invention, the manually performed process step can be documented, wherein documentation obligations can be fulfilled when carrying out safety-critical process steps.

The machine learning system having the decision algorithm can be run, for example, on a computing unit, wherein the computing unit together with the digital image sensors can be housed in a mobile device and carried by the person concerned. However, it is also conceivable that the digital computing unit with the decision algorithm is part of a larger data processing system to which the image recording device or the digital image sensors are connected wirelessly or wired. Of course, a mixed form of both variants, i.e., both a central and a decentralized provision of the decision algorithm is also conceivable.

The decision algorithm of the machine learning system is an artificial neural network, which receives as corresponding input data the digital image data (in the processed state or in an unprocessed state) via the corresponding input neurons and generates an output by means of corresponding output neurons of the artificial neural network, wherein the output characterizes a process state of the industrial subprocess. Due to the ability to train the artificial neural network with its weighted connections in a training process in such a way that it can generalize the learning data, the currently recorded image data can be provided as input data to the artificial neural network, so that it can assign a corresponding process state to the recorded image data based on what has been learned.

The digital image data is recorded by at least one mobile device, wherein the mobile device is carried by a person involved in the industrial process step and wherein the digital image sensor or sensors are arranged on the mobile device. The image data recorded by the mobile device is then transmitted to the machine learning system having the at least one decision algorithm.

Such a mobile device may, for example, include or be a portable glasses design worn by a person, wherein at least one image sensor is arranged on the portable glasses design. By means of the glasses design worn by the person, the image data is now recorded and transferred to the machine learning system having the decision algorithm. The digital image sensors are arranged on the glasses design in such a way that they record the person's range of vision when the glasses design is worn by the person as eyeglasses. Since the head is usually aligned in the direction of view, the person's area of section of handling is also preferably recorded when they look in the respective direction. Such mobile devices with glasses design can be, for example, VR glasses (virtual reality) or AR glasses (augmented reality).

The glasses design may be connected to the computing unit described above or include such a computing unit. It is conceivable that the glasses design has a communication module to communicate with the computing unit if the computing unit with the knowledge base of the machine learning system is arranged in a remote location. Such a communication module may, for example, be wireless or wired and address corresponding communication standards such as Bluetooth, Ethernet, WLAN and the like. With the help of the communication module, the image data and/or the current process state, which has been recognized with the aid of a decision algorithm, can be transmitted.

The output unit for providing a visual, acoustic and/or haptic output may be arranged in such a way on the glasses design that the output unit can generate a corresponding, visual, acoustic and/or haptic output to the person. In the case of a corresponding augmented reality system with glasses, it is conceivable that a corresponding cue of a visual nature is projected in the person's field of vision in order to transmit the process state determined from the machine learning system to the person as a corresponding output. If, for example, the position of the glasses design within the space and the orientation of said position are known, then in addition to the purely visual output, an output that is specific to said position can also be made, i.e., the environment of the person, which is perceived through the eyes of the person, is virtually extended by appropriate cues so that these cues are located directly on the respective object in the person's environment.

Acoustic output in the form of voice outputs, sounds or other acoustic cues is also conceivable. Haptic output is also conceivable, for example in the form of a vibration or similar.

Digital image sensors can be, for example, 2D image sensors for capturing 2D image data. In this case, a digital image sensor is usually sufficient. However, it is also conceivable that the digital image sensors are 3D image sensors for recording digital 3D image data. A corresponding combination of 2D and 3D image data is also conceivable. This 2D image information or 3D image information is then provided as input data in accordance with at least one decision algorithm of the machine learning system in order to obtain the process states as output data. Through the 3D image data, or in combination with 2D and 3D image data, a much higher accuracy of results is achieved. Thus, as a function of 3D image data or combinations of 2D and 3D image data, corresponding (additional) parameters of physical objects can be recorded, such as, e.g., size and ratio, and be taken into account when determining the current process state. Moreover, additional depth information using 3D image data can be determined in the context of the invention and taken into account in the determination of the current process state.

By means of the 3D image data, objects in particular can be scanned, measured and/or the distance to them can be measured and taken into account when determining the current process state. This improves the method, as further information, for example for detecting defective components, is recorded and evaluated, thus improving the process step of quality assurance.

The 3D image sensors can be, for example, a so-called time-of-flight camera. However, there are also other, known image sensors that can be used in the context of the present invention.

In addition, it is conceivable that the parameters determined from the 3D image data, such as size, ratio, distance, etc., which can be derived directly or indirectly from the 3D image data, were at least partially learned. Thus, the decision algorithm contains not only a correlation between image data and process state, but additionally in an advantageous embodiment also a correlation between process parameters, derived from the 3D image data or a combination of 2D and 3D image data, and the process state. This can improve recognition accuracy.

Mobile devices with image sensors, however, can also be telephones, such as smartphones, or tablets. In addition to an image acquisition unit, the mobile devices can also contain an output unit, so that the respective person carrying the mobile device can also perceive a corresponding output of the output unit through the mobile device.

The monitoring system can be set up in such a way that in a training mode the at least one decision algorithm of the machine learning system is learned by the recorded digital image data. It is conceivable that the decision algorithm of the machine learning system is first trained in training mode and then operated exclusively in a productive mode. However, a combination of training mode and productive mode is also conceivable, so that not only the process states are continuously determined as output data from the decision algorithm of the machine learning system, but also the decision algorithm (and the knowledge base stored in it) is continuously learned (for example in the form of an open learning process). This makes it possible to continuously develop the decision-making algorithm in order to improve the output behavior.

It is conceivable that the decision algorithm of the machine learning method, in a first possible alternative, runs on the computing unit as an instance, so that productive mode and, if necessary, training mode are run on one and the same knowledge base or with one and the same decision algorithm. In a further alternative, however, it is also conceivable that the at least one decision algorithm runs on two separate computing units or is present in the computing unit as at least two instances, wherein the productive mode of a first instance of the decision algorithm is run, while at the same time the training mode is run on a second instance. Thus, in productive mode, the decision algorithm remains unchanged, while the second instance of the decision algorithm is continuously refined. The second alternative is particularly advantageous if the machine learning system having the decision algorithm is run on a mobile computing unit. Since the computing capacity for a complex training mode is usually not available here, only the productive mode can be run when using mobile computing units, while another knowledge database is continuously learned on a remotely arranged second computing unit (for example, a server system).

Consequently, it is advantageous if, in a training mode using a training module of the machine learning system, one or more parameters of the decision algorithm are learned based on the recorded digital image data and/or if in a productive mode the decision algorithm of the machine learning system is used to determine the at least one current process state of the industrial process step.

The at least one current process state of the industrial process step can be determined by the decision algorithm run on at least one mobile device, wherein the mobile device is carried by a person involved in the industrial process step. It is conceivable that a large number of mobile devices are also available, each of which executes a corresponding decision algorithm of the machine learning system, so that a correspondingly current process state can be determined on each mobile device by using the executed decision algorithm.

In this case, it is conceivable if the recorded digital image data is transmitted to a data processing system accessible over a network, wherein one or more parameters of the decision algorithm are learned based on the recorded digital image data using a training module of the machine learning system run on the data processing system and then the parameters of the decision algorithm are transmitted from the data processing system to the mobile device carried by the person and based on the decision algorithm.

This makes it possible to continuously train the decision algorithm with the recorded digital image data and then transfer the parameters of the learned decision algorithm to the respective mobile device at regular intervals in order to continuously improve the base, i.e., the knowledge base, for the decision algorithm. Due to the fact that the mobile devices do not have the necessary computing capacity to train the parameters of the decision algorithm based on newly recorded image data, it is advantageous to run the productive mode and the training mode on the hardware of different devices. For training such a decision algorithm, large server systems are particularly well suited.

It is also conceivable that the recorded digital image data can be transmitted to a data processing system accessible over a network, wherein the at least one current process state of the industrial process step is determined by the decision algorithm run on the data processing system, wherein then, as a function of the determined current process state of the industrial process step, the output unit for generating the visual, acoustic and/or haptic output is controlled by the data processing system. It may be provided that one or more parameters of the decision algorithm are learned based on the recorded digital image data using a training module of the machine learning system run on the data processing system. The control of the output unit can be carried out directly by the data processing system or indirectly by interposition of the mobile device or devices.

The productive mode and, if necessary, the training mode can be run on the data processing system accessible in the network, so that only the image data of the image sensors are transmitted from the mobile devices and, if the output unit is arranged on the mobile devices, the result of the current process state is transmitted back to the mobile devices.

Each mobile device can have its own decision-making algorithm on the data processing system, which is learned in training mode. The data processing system can be set up in such a way that it combines the decision algorithms to improve the result in order to further optimize them. However, it is also conceivable that there is only a single decision algorithm for a large number of mobile devices on the data processing system, which is trained in training mode by the inputs of many different mobile devices.

If several decision algorithms are available on the data processing system, it is also conceivable that they are trained independently of each other and then the best, trained decision algorithm is selected. The selection can be made on the basis of different criteria, such as recognition quality, simplicity of the knowledge structure, etc.

In this context, therefore, it is particularly advantageous if a decision algorithm, for example, available on the data processing system, is selected from several, independently learned decision algorithms as a function of a selection criterion and/or an optimization criterion. Such a selection criterion and/or optimization criterion can be, for example, the recognition quality, the simplicity, the knowledge structure, properties of the mobile device on which the decision algorithm is run, etc.

The selected decision algorithm can then be used to determine the current process state. This can be done, for example, by transmitting the image data to the data processing unit and using the selected decision algorithm as input data. However, this can also be done by transferring the decision algorithm to the mobile device in question and applying it there.

This allows for an efficient selection of a decision algorithm, which is optimally adapted to the present situation. For example, the decision algorithm can be selected in such a way that it is optimally adapted to the mobile device. If, for example, the mobile device is a resource-limited or resource-poor device (reduced performance compared to other mobile devices), a decision algorithm can be selected that is optimally adapted to the resource conditions prevailing on the mobile device. This could mean, for example, that the decision algorithm is less computationally intensive and can therefore be optimally run on the mobile device (but may have reduced accuracy or speed or efficiency). This can be achieved, for example, with a simplified knowledge structure of the decision-making algorithm. Of course, this also applies to the monitoring system.

However, it is also conceivable that the productive mode is run on the mobile devices and thus each mobile device has a decision algorithm, wherein the parameters of a decision algorithm existing there are then transmitted by the data processing system and the decision algorithms trained there to all (or a selection of) mobile devices in order to combine different learned decision algorithms on the mobile devices.

The object is also achieved with the monitoring system that includes: at least one image acquisition unit having at least one digital image sensor for recording digital image data; a machine learning system having at least one machine-trained decision algorithm containing a correlation between digital image data as input data of the machine learning system and process states of the industrial process step to be monitored as output data of the machine learning system; at least one computing unit for determining at least one current process state of the industrial process step using the decision algorithm executable on the computing unit by generating, based on the trained decision algorithm, at least one current process state of the industrial process step as output data of the machine learning system from the recorded digital image data as input data of the machine learning system; and an output unit that is set up to generate visual, acoustic and/or haptic output to a person as a function of the at least one current process state determined.

Thus, it may be provided that the machine learning system is or contains an artificial neural network as a decision algorithm.

Furthermore, it may be provided that the monitoring system has at least one mobile device which is designed to be carried by at least one person and on which the at least one digital image sensor of the image acquisition unit is arranged in such a way that the digital image data are recordable, wherein the mobile device is set up to transmit the recorded digital image data to the machine learning system.

Furthermore, it may be provided that the monitoring system has a training mode in which one or more parameters of the decision algorithm are learned based on the recorded digital image data using a training module of the machine learning system and/or the monitoring system has a productive mode in which at least one current process state of the industrial process step is determined by the decision algorithm of the machine learning system.

Furthermore, it may be provided that the monitoring system has a mobile device with a computing unit, which can be carried by a person involved in the industrial process step, wherein the mobile device is set up to determine the at least one current process state of the industrial process step using the decision algorithm executed on the computing unit.

Furthermore, it may be provided that the monitoring system has a data processing system accessible over a network, which is set up to receive the digital image data recorded by the image acquisition unit, to learn one or more parameters of the decision algorithm based on the received digital image data by means of a training module of the machine learning system run on the data processing system and then to transmit the parameters of the decision algorithm from the data processing system to the mobile device carried by the person.

Furthermore, it may be provided that the monitoring system has a data processing system accessible over a network, which is set up to receive the digital image data recorded by the image acquisition unit, to determine at least one current process state of the industrial process step by means of the decision algorithm executed on the data processing system and, as a function of the determined current process state of the industrial process step, to control the output unit for generating the visual, acoustic and/or haptic output.

In this case, it may be provided that the data processing system is further set up to learn one or more parameters of the decision algorithm based on the received digital image data using a training module of the machine learning system run on the data processing system, and to base these on the decision algorithm.

In principle, it can always be provided that more than one decision algorithm is available, in particular one decision algorithm for the training mode or the training module and one decision algorithm for the productive mode or the productive module. A separate decision algorithm can be available for each mobile device both in training mode and in productive mode. However, it is also conceivable that a separate decision algorithm exists for a certain group of mobile devices, which is learned by the group of mobile devices together in training mode. A decision algorithm trained in this way for a group of mobile devices is then transmitted only to the mobile devices in said group in terms of its parameters.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of the monitoring system;

FIG. 2 is a schematic representation of the mobile device; and

FIG. 3 is a schematic representation of a data processing system.

### DETAILED DESCRIPTION

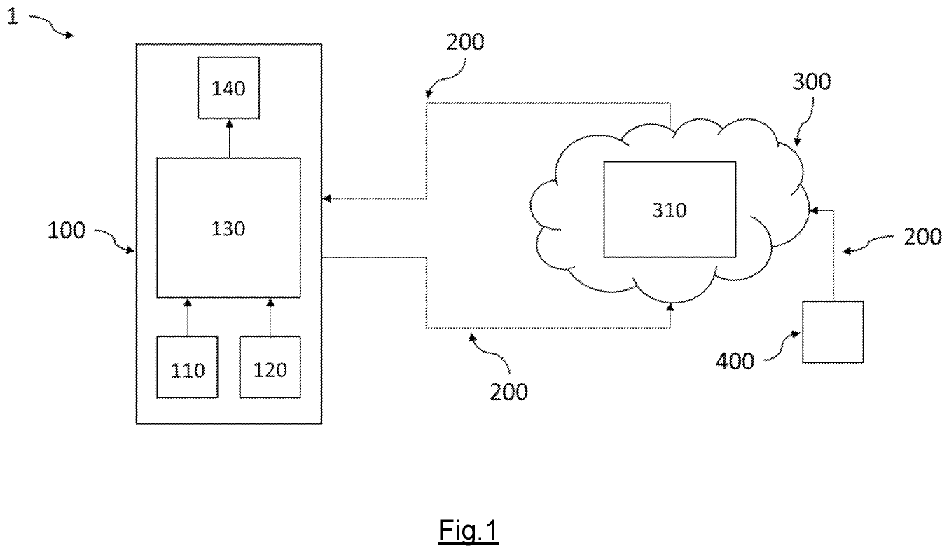

FIG. 1 shows schematically in a very simplified representation the individual components of the monitoring system 1, with which a manual industrial process step of an industrial process, not shown, is to be monitored. In the embodiment of FIG. 1, the monitoring system 1 comprises an augmented reality system 100, which in the form of a mobile device has at least two image sensors 110 and 120. The first image sensor 110 is a 2D image sensor for capturing 2D image data, while the second image sensor 120 is a 3D image sensor for capturing digital 3D image data.

The digital image data recorded by the image sensors 110 and 120 is then made available to a first computing unit 130, which, based on its calculations, then controls an output unit 140 of the augmented reality system 100. The output unit 140 is designed to provide a visual, acoustic and/or haptic output to a person.

Both the image sensors 110 or 120 and the output unit 140 do not necessarily have to be an integral part of a mobile device. It is also conceivable that these are distributed components that are only linked to the computing unit 130 by the mobile device. Conceivable and preferred, however, is an integral solution in which the mobile device, for example AR glasses or VR glasses, contains both the image sensors 110 or 120 and the output unit 140.

Thus, it is advantageous if the image sensors 110 or 120 per se and the output unit 140 are part of a glasses design, which is worn by the relevant person as glasses. The first computing unit 130 can also be part of the glasses, whereby a very compact design is made possible. However, it is also conceivable that the computing unit 130 is worn in the form of a mobile device on the body of the relevant person and is wired and/or wirelessly connected to the glasses.

The monitoring system 1 also has a data processing system 300, which is connected via a network 200 with the mobile device 100 or the augmented reality system 100. The data processing system 300 has a second computing unit 310, which is set up accordingly in association with the determination of the current process state. For example, the second computing unit 310 of the data processing system 300 can run a training module with which a decision algorithm is trained. It is also conceivable that the second computing unit 310 runs a productive module with which the current process state is determined based on a decision algorithm.

Furthermore, a configuration unit 400 to the data processing system 300 can be accessed via the network 200, which may contain information in particular regarding the classification of the images. This is useful, for example, if the recorded image data, be it 2D image data or 3D image data, has been previously analyzed and, possibly, classified.

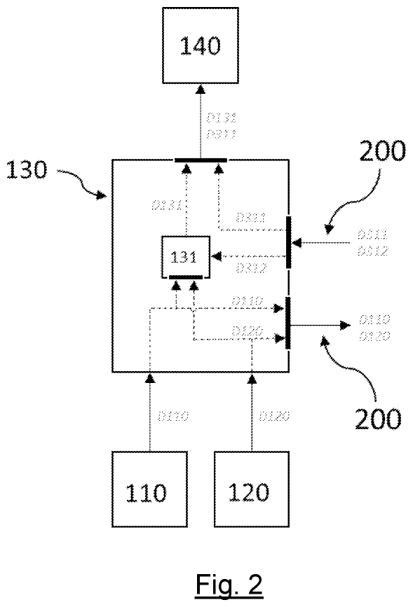

FIG. 2 schematically shows the augmented reality system 100 with the first computing unit 130 and the data transmitted in the various embodiments. To begin with, the first computing unit 130 receives the 2D image data D110 from the 2D image sensor 110. Furthermore, the first computing unit 130 receives the 3D image data D120 from the 3D image sensor. Of course, it is conceivable that only either the 2D image data D110 or the 3D image data D120 of the first computing unit 130 are provided.

The image data D110 and/or the image data D120 are provided to the first decision module 131 of the first computing unit 130 of the augmented reality system 100, wherein the first decision module for running a decision algorithm, for example in the form of a neural network, is formed. The decision algorithm of the first decision module 130 is part of a machine learning system and contains a correlation between digital image data as input data on the one hand and process states of the industrial process step to be monitored as output data on the other. The decision algorithm of the first decision module 131 is now fed with the image data D110 and/or D120 as input data and then determines the current process state D131 as output data. The current process state D131 is locally generated decision data generated by the decision algorithm run on the first computing unit using the first decision module 131. This current process state D131 determined in this way is then transmitted via an interface of the first computing unit 130 to the output unit 140, where a corresponding acoustic, visual and/or haptic output can take place. The output unit 140 may be designed in such a way that it generates a corresponding output directly on the basis of the determined current process state D131. However, it is also conceivable that based on the current process state D131, a corresponding control of an output unit 140 existing without further intelligence takes place.

The augmented reality system 100 may operate independently of a possibly existing server system with regard to the productive mode, wherein the decision algorithm can be trained or remain untrained. It is conceivable that the first decision module will also carry out a training mode in order to further train the decision algorithm available in the first decision module. Training mode and productive mode are thus run together by the first computing unit 130.

It is conceivable that the image data D110 and D120 are transmitted to the data processing system 300 already known from FIG. 1 and the second computing unit 310 present there via the network 200. Depending on which functionality the data processing system 300 implements, the result of the first computing unit 130 of the augmented reality system 100 can be either a remotely determined current process state D311 or parameter D312 of the further trained decision algorithm. However, it is also conceivable that both data sets D311, D312 of the first computing unit 130 are provided.

If the parameters D312 of the decision algorithm further trained by the data processing system are provided by the data processing system 300 via the network 200, these parameters D312 are made available to the first decision module 131. The decision algorithm existing there is now supplemented or extended or replaced by the parameters D312, so that the productive mode of the first decision module 131 is based on a decision algorithm trained in the data processing system. At the same time, of course, the image data D110 and D120 will continue to be provided to the first decision module 131 in order to determine the current process state D131 locally by the first computing unit 130. The base of the decision module 131 is constantly improved by a remotely trained decision algorithm, which can improve the recognition rate.

However, it is also conceivable that alternatively or in parallel, the data processing system 300 determines the current process state in a productive mode of a second computing unit 310 and then provides it to the first computing unit 130. If the current process state is determined only by the data processing system 300, this is then transferred to the output unit 140 as data D311. However, if at the same time a corresponding current process state D131 is determined by the first computing unit and the decision module 131 contained therein, both process states are made available to the corresponding output unit. This can then generate a corresponding output from the two process states (local: D131, remote: D311).

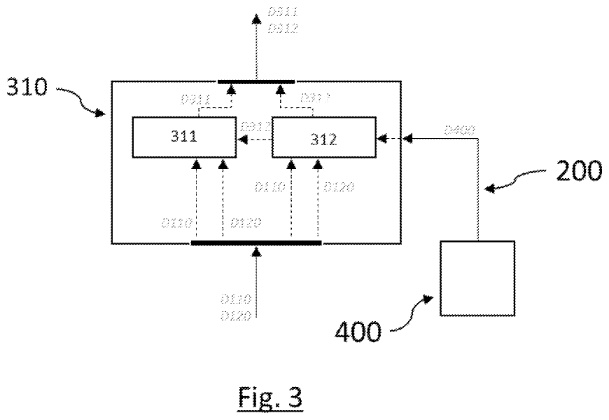

FIG. 3 shows in a schematically detailed view the data flow of the second computing unit 310 of the data processing system 300. As already mentioned in FIG. 2, the image data D110 and D120 are transmitted via the network to the second computing unit 310. The second computing unit 310 may have a second decision module 311 and/or a training module 312, wherein both modules, if both are available, are also provided with the respective image data D110 and D120.

The second decision module 311 has one or more decision algorithms that contain a correlation between the digital image data D110, D120 as input data and process states D311 as output data. The output data D311 in the form of current process states are then transmitted back to the augmented reality system 100 (see FIG. 2) via the network.

Furthermore, the second computing unit 310 may have a training module 312, which also receives the image data D110 and D120. With the help of the training module, the parameters of the decision algorithm are then learned in a corresponding learning process and then, if appropriate, provided to the decision module 311 in the form of parameter data D312. The newly learned parameters D312 of the decision algorithm can in turn be provided by the training module 312 via the network to the augmented reality system 100.

The transfer of the learned parameters D312 to the augmented reality system 100 can take place at discrete, not necessarily fixed times. It is also conceivable that these parameters D312 of the decision algorithm are transmitted to more than one augmented reality system connected to the data processing system 300.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for monitoring an industrial process step of an industrial process via a monitoring system, the method comprising:
providing a machine learning system of the monitoring system that contains a correlation between digital image data as input data and process states of the industrial process step to be monitored as output data using at least one machine-trained decision algorithm;
recording digital image data via at least one image sensor of at least one image acquisition unit of the monitoring system;
determining at least one current process state of the industrial process step using the decision algorithm of the machine learning system by generating at least one current process state of the industrial process step as output data of the machine learning system based on the trained decision algorithm; and
monitoring the industrial process step by generating a visual, acoustic and/or haptic output via an output unit as a function of the at least one determined current process state.

2. The method according to claim 1, wherein the machine learning system contains an artificial neural network as a decision algorithm.

3. The method according to claim 1, wherein the digital image data are recorded by at least one mobile device that is adapted to be carried by a person involved in the industrial process step and on which at least one digital image sensor of an image acquisition unit is arranged and are transmitted to the machine learning system.

4. The method according to claim 1, wherein, in a training mode, using a training module of the machine learning system, one or more parameters of the decision algorithm are learned based on the recorded digital image data, and/or wherein, in a productive mode, using the decision algorithm of the machine learning system, the at least one current process state of the industrial process step is determined.

5. The method according to claim 1, wherein the at least one current process state of the industrial process step is determined by the decision algorithm run on at least one mobile device, which is adapted to be carried by a person involved in the industrial process step.

6. The method according to claim 5, wherein the recorded digital image data are transmitted to a data processing system accessible over a network, wherein one or more parameters of the decision algorithm are learned based on the recorded digital image data using a training module of the machine learning system that is run on the data processing system and then the parameters of the decision algorithm are transmitted from the data processing system to the mobile device adapted to be carried by the person and are based on the decision algorithm.

7. The method according to claim 1, wherein the recorded digital image data are transmitted to a data processing system accessible over a network, wherein the at least one current process state of the industrial process step is determined by the decision algorithm run on the data processing system, wherein subsequently, as a function of the determined current process state of the industrial process step, the output unit is controlled by the data processing system for generating the visual, acoustic and/or haptic output.

8. The method according to claim 7, wherein one or more parameters of the decision algorithm are learned based on the recorded digital image data using a training module of the machine learning system which is run on the data processing system.

9. The method according to claim 1, wherein, on the data processing system, a plurality of decision algorithms is stored, which was or is independently trained, wherein as a function of a selection criterion and/or optimization criterion, a decision algorithm is selected from this plurality of decision algorithms, and wherein the selected decision algorithm is used as a basis for determining the current process state.

10. A monitoring system for monitoring an industrial process step of an industrial process, the monitoring system comprising:
at least one image acquisition unit having at least one digital image sensor to record digital image data;
a machine learning system having at least one machine-trained decision algorithm containing a correlation between digital image data as input data of the machine learning system and process states of the industrial process step to be monitored as output data of the machine learning system;
at least one computing unit to determine at least one current process state of the industrial process step using the decision algorithm which is executable on the computing unit, in that, based on the trained decision algorithm, at least one current process state of the industrial process step is generated as output data of the machine learning system from the recorded digital image data generated as input data of the machine learning system; and
an output unit that is set up to generate a visual, acoustic and/or haptic output to a person as a function of the at least one determined current process state.

11. The monitoring system according to claim 10, wherein the machine learning system comprises an artificial neural network as a decision algorithm.

12. The monitoring system according to claim 10, wherein the monitoring system includes at least one mobile device, which is designed to be carried by at least one person and on which the at least one digital image sensor of the image acquisition unit is arranged in such a way that digital image data are recordable, wherein the mobile device is set up to transmit the recorded digital image data to the machine learning system.

13. The monitoring system according to claim 10, wherein the monitoring system has a training mode in which one or more parameters of the decision algorithm are learned based on the recorded digital image data using a training module of the machine learning system, and/or wherein the monitoring system has a productive mode in which the decision algorithm of the machine learning system determines at least one current process state of the industrial process step.

14. The monitoring system according to claim 10, wherein the monitoring system has a mobile device comprising a computing unit and is adapted to be carried by a person involved in the industrial process step, wherein the mobile device is set up to determine the at least one current process state of the industrial process step using the decision algorithm executed on the computing unit.

15. The monitoring system according to claim 14, wherein the monitoring system has a data processing system accessible over a network, which is set up to receive the digital image data recorded by the image acquisition unit, to learn one or more parameters of the decision algorithm based on the received digital image data using a training module of the machine learning system which is run on the data processing system and then to transmit the parameters of the decision algorithm from the data processing system to the mobile device carried by the person.

16. The monitoring system according to claim 10, wherein the monitoring system has a data processing system accessible over a network, which is set up to receive the digital image data recorded by the image acquisition unit, to determine at least one current process state of the industrial process step using the decision algorithm executed on the data processing system and, as a function of the determined current process state of the industrial process step, to control the output unit for generating the visual, acoustic and/or haptic output.

17. The monitoring system according to claim 16, wherein the data processing system is further set up to learn one or more parameters of the decision algorithm based on the received digital image data using a training module of the machine learning system run on the data processing system and to base these on the decision algorithm.

18. The monitoring system according to claim 10, wherein the monitoring system is designed to carry out a method comprising:
providing a machine learning system of the monitoring system that contains a correlation between digital image data as input data and process states of the industrial process step to be monitored as output data using at least one machine-trained decision algorithm;
recording digital image data via at least one image sensor of at least one image acquisition unit of the monitoring system;
determining at least one current process state of the industrial process step using the decision algorithm of the machine learning system by generating at least one current process state of the industrial process step as output data of the machine learning system based on the trained decision algorithm; and
monitoring the industrial process step by generating a visual, acoustic and/or haptic output via an output unit as a function of the at least one determined current process state.
